(19) United States
(12) Patent Application Publication
(10) Pub. No.: US 2006/0268557 A1
(43) Pub. Date: Nov. 30, 2006

(54) Event light shade

(76) Inventor: Vicente Tudela Cruz, Long Beach, CA (US)

Correspondence Address: Vicente T. Cruz, 3327 Rutgers Avenue, Long Beach, CA, 90808, US

(21) Appl. No.: 11/139,171

(22) Filed: May 25, 2005

(51) Int. Cl. F21V 11/00

(52) U.S. Cl. 362/351

(57) ABSTRACT

A non-powered transparent or translucent light shade formed, shaped or textured, tinted and/or painted which is rested on a fully adjustable bracket then placed over an existing wall-mounted light fixture, floor or table lamp. With the light fixture switched to the on position, the light shade is then back-lit and illuminated to express the design of an event, a holiday, a season, personal, religious, sports/teams, political, or any other event designed into each light shade.

This invention is referred to as “Event Light Shade” or ELS. This invention was created by Vicente Cruz, the applicant of this patent. Vicente is a U.S. citizen born in Guam, USA, in October, 1948. He was a member of the U.S. Air Force from 1969 to 1973 and was granted an honorable discharge upon separation. Vicente has been a resident of Southern California from 1974 to present.

The ELS is intended to express holidays, personal, family, or seasonal events through the use of “themed” transparent, translucent or combinations of any other type of materials formed to fit over existing outdoor light fixtures or existing table or floor lamps. The existing fixtures will illuminate the ELS to display the “event” design. The ELS shall be provided with adjustable universal brackets and shall be simply placed over existing outdoor or indoor wall mounted light fixtures, table or floor lamps. The ELS is designed to be reused as each appropriate event occurs, re-packed in the original carton for storage.

CROSS-REFERENCE TO RELATED APPLICATIONS

| | | | |
|---|---|---|---|
| D370,295 | May 28, 1996 | Kang | D26/128-136 |
| D368,979 | Apr. 16, 1996 | Jasper-Fayer | D26/124 |
| D370,078 | May 21, 1996 | Sung | D26/133 |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Homes have increasingly been expressing holidays, seasonal or family events with the use of exterior decorative lights, string of lights or banners added to the exterior of their home during holidays or other events. These events or holidays include New Year's, Easter, July 4^{th}, Halloween, Thanksgiving, Christmas, Super Bowl or other championship sporting events. Personal or family events may include birthdays, or a recent childbirth.

This invention shall be simply placed over existing indoor or outdoor wall-mounted light fixtures or, simply replace the existing shades of indoor table or floor lamps. Each ELS shall be as easy to use, easy to remove and easy to store until the next appropriate event. Unlike other currently available event or holiday lights, the ELS's are illuminated by the light generated by the existing light fixtures. The ELS's will not require any electrical cords, wiring, light bulb sockets, light bulbs, or switches.

### BRIEF SUMMARY OF THE INVENTION

This invention is intended to provide another application and/or use of existing indoor or outdoor wall-mounted light fixtures, existing table or floor lamps. The ELS shall be supported by existing wall mounted light fixtures, or could be switched with the lamp shade of an existing table or floor lamp for the duration of a holiday or event. The ELS shall be secured to the existing lamps with the existing shade removed reusing the existing fasteners. The ELS's is designed for use with two types of fixtures. The ELS-1 is intended for use over existing wall-mounted light fixtures. The ELS-2 is intended to replace the lamp shade of a floor or table lamp using the existing harp or lamp base & hardware.

This ELS is designed to be easily installed and easily removed in both versions. This invention will offer an alternate use for existing light fixtures, both indoor and outdoors without having to tap into additional electrical outlets or extension cords.

### DETAILED DESCRIPTION OF THE INVENTION

This new product is referred to as the Event Light Shade (ELS). It is designed to be utilized with the existing light fixtures found in most homes.

The ELS's shall be constructed of approximately 1/16-inch thick acrylic, plexi-glass, formed or molded plastic or any transparent or translucent material or combination of materials. The dimensions of the ELS shall be such that the majority of the existing wall mounted indoor and outdoor light fixtures, existing table and floor lamps shall accept the ELS's without any modifications.

ELS materials shall be transparent and/or translucent shaped and formed to partially cover existing fixtures. The light omitted by the fixture will illuminate the ELS to display the intended design and/or words expressing the personal event or holiday. The shape of the ELS can be a formed circle, square, rectangle or any shape in the design of a particular item for a particular personal event, season, or holiday. ELS's shall be available in a variety of colors and can be any color or combination of colors formed to cover most of the existing fixture.

The formed or molded plastic shall be supported by adjustable metal strapping and hardware so that the ELS can be placed over most existing wall-mounted light fixtures, table or floor lamps. The illuminated segment of the ELS shall be installed allowing approximately 2-inches or more from any point of the fixture to allow heat to dissipate.

There are two versions or applications of this invention. Version one, ELS-1, is designed to be used with wall-mounted indoor or outdoor light fixtures. Version two, ELS-2, is designed for use with existing table or floor lamps by simply switching the existing lampshade with the ELS-2 using the existing fastener and harp.

Both ELS-1 and ELS-2 shall be transparent or translucent designed to be illuminated by the generated light when placed over the existing light fixtures. The ELS's when illuminated by the existing light fixtures, shall display combined graphics, colors, shapes and/or text to express events such as a holiday, a seasonal image, a personal or family celebration.

The ELS-1 shall be supported by the existing wall-mounted indoor or outdoor light fixture and does not require fastening to the light fixture or any building elements.

The ELS-2 shall be supported by existing table lamps or floor lamps. The ELS-2 and the hardware provided shall replace the existing lampshades while in use. The ELS-2 shall be illuminated by light generated by the existing lamp.

1. A non-powered decorative light shade constructed of translucent or transparent material or a combination thereof formed, shaped or textured, tinted and/or artistically painted to express a holiday, a season, personal, religious, sports/teams, political, or any other event that is placed over wall mounted indoor or outdoor light fixtures with the use of a universally adjustable bracket placed and resting on the light fixture and wall. When the light fixture switched is placed in the on position, the light shade is illuminated, back-lit, by the light fixture, radiating, expressing the design of the intended event.

2. A non-powered decorative light shade as described in claim 1, designed to replace the lampshade of existing table or floor lamps using similarly designed wire-frame and fasteners as the existing lampshade with a harp type lampshade support; or a using a lampshade frame structure that is similarly design as the existing lampshade placed on the base of the light bulb socket. The light shade when placed over an existing lamp shall be positioned approximately center vertically to the existing light bulb. When the lamp switch is placed in the on position, the light shade is illuminated by the lamp, radiating, expressing the design of the intended event.
